(19) United States
(12) Patent Application Publication
(10) Pub. No.: US 2021/0389979 A1
(43) Pub. Date: Dec. 16, 2021

(54) MICROPROCESSOR WITH FUNCTIONAL UNIT HAVING AN EXECUTION QUEUE WITH PRIORITY SCHEDULING

(71) Applicant: ANDES TECHNOLOGY CORPORATION, Hsinchu City (TW)

(72) Inventor: Thang Minh Tran, Saratoga, CA (US)

(73) Assignee: ANDES TECHNOLOGY CORPORATION, Hsinchu City (TW)

(21) Appl. No.: 16/901,012

(22) Filed: Jun. 15, 2020

(51) Int. Cl. G06F 9/48; G06F 9/30; G06F 9/38

(52) U.S. Cl. CPC G06F 9/4881; G06F 9/30098; G06F 9/3855; G06F 9/3016

(57) ABSTRACT

A data processing system includes a priority scheduler and execution queue between an instruction decode unit and a functional function. The priority scheduler determines whether a source operand data specified by an instruction issued by the instruction decode unit is ready or not. The priority scheduler prioritizes the decoding instruction having all of the source operand data ready over the ready instruction from the execution queue to send to the functional unit. The decoding instruction having a data dependency is placed into the execution queue.

### BACKGROUND

### Technical Field

The disclosure generally relates to a data processing system, and more specifically, to configure the data processing system to handle data dependency in an out-of-order environment.

### Description of Related Art

In an instruction pipeline of data processing system, an instruction is decoded and issued in an order to a functional unit to perform an operation designated by the opcode of the instruction. In some cases, source operand data designated by the instruction is not ready, where the source operand data may be a result data of the functional unit or other functional unit or data to be loaded from cache or memory. Instructions with data dependency go to an execution queue or reservation station to be sent to a functional unit at later time for execution. The mechanism to issue instructions from the queue or reservation station are either complex, large, and power hungry or not optimal for performance and limited by the queue size.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram illustrating a data processing system 10 according to some embodiments of the disclosure.

FIG. 2 is a block diagram illustrating instruction pipeline architecture of the CPU 110 as illustrated in FIG. 1 according to some embodiments of the disclosure.

FIG. 3 is a diagram illustrating a priority scheduler for selectively sends an instruction to a functional unit according to some embodiments of the disclosure.

FIG. 4 is a diagram illustrating a priority scheduler for selectively sends an instruction to a functional unit according to some embodiments of the disclosure.

FIG. 5 is a flowchart diagram illustrating an issuance of an instruction from either an instruction decode unit or an execution unit to the functional unit through a priority scheduler according to some embodiments of the disclosure.

### DESCRIPTION OF THE EMBODIMENTS

The following disclosure provides many different embodiments, or examples, for implementing different features of the present disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

To avoid stalling of the instruction pipeline due to data dependency, an execution queue with priority scheduler logic is placed between an instruction decode/issue unit and a functional unit. The execution queue with priority scheduler logic prioritizes the instruction issued by the instruction decode/instruction issue unit without data dependency and placing only issued instruction with data dependency into the execution queue. In some embodiments of the disclosure, the execution queue selects between the issued instruction and instructions from the entries of the execution queue (e.g., first 2 entries in the execution queue) with the highest priority given to the issued instruction if it has no data dependency. This priority scheme can achieve similar performance in comparison with, for example, the reservation station with much more complexity and power hungry. In the reservation station, all instructions in all entries are actively checking for data dependency and priority is given to oldest instruction. With the execution queue and the priority scheduler logic in this disclosure, the data processing system is much simpler, smaller, and less power but with the same performance as in totally out-of-order method. The reason for performance advantage for disclosed priority scheme is that putting the instructions without data dependency into the queue create another data dependency chain especially the instruction is part of the loop branch instructions. For example, a loop count instruction to count down the iterations for a loop is often without data dependency and putting loop count instruction into the execution queue will cause the next loop iteration to stall.

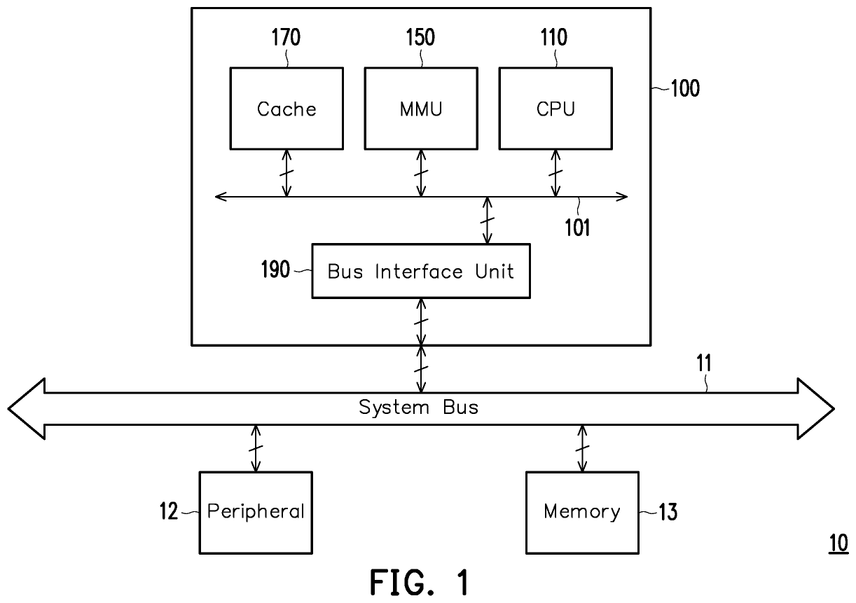

FIG. 1 is a block diagram illustrating a data processing system 10 according to some embodiments of the disclosure. The data processing system 10 includes a processor 100, a system bus 11, a memory 13 and one or more peripheral(s) 12. The memory 13 is a system memory that is coupled to the system bus 11 by a bidirectional conductor that has multiple conductors. The peripheral(s) 12 is coupled to the system bus 11 by bidirectional multiple conductors. The processor 100 includes a bus interface unit (1311j) 190 that is coupled to the system bus 11 via a bidirectional bus having multiple conductors. The processor 100 may communicate with the peripheral(s) 12 or the memory 13 via the system bus 11. The bus interface unit 190 is coupled to an internal bus 101 via bidirectional conductors. The internal bus 101 is a multiple-conductor communication bus. The memory 13 is configured to store program codes of instructions and data that are needed for the execution of the instructions. The memory 13 may include non-volatile memory or volatile memory or a combination thereof. For example, the memory 13 may include at least one of random access memory (RAM), dynamic random access memory (DRAM), static random access memory (SRAM), read only memory (ROM), programmable read only memory (PROM), electrically programmable read only memory (EPROM), electrically erasable programmable read only memory (EEPROM), and flash memory.

The processor 100 includes a central processing unit (CPU) 110, a memory management unit (MMU) 150, and a cache 170. The CPU 110 is a processor for implementing data processing operations. Each of CPU 110, MMU 150, and the cache 170 are coupled to the internal bus 101 via a respective input/output (I/O) port or terminal and communicate therebetween. The processor 100 functions to implement a variety of data processing functions by executing a plurality of data processing instructions. Cache 170 are a temporary data store for frequently-used information that is needed by the CPU 110. For example, the cache 170 may be an instruction cache, a data cache, level two cache, etc. Information needed by the CPU 110 that is not within cache 170 are stored in memory 13. The microprocessor 100 may include branch prediction unit (not shown), co-processor (not shown), and other enhancements that are not relevant to the disclosure.

The MMU 150 controls interaction of information between the CPU 110 and the cache 170 and the memory 13. The MMU 150 also includes an instruction translation lookaside buffer (e.g., iTLB), a data translation lookaside buffer, and level-2 translation lookaside buffer, etc. The TLB may store the recent translations of virtual address to physical address, which may be used for quick virtual address lookup. The virtual address is an address that is used by CPU 110 and by code that is executed by CPU 110. The physical address is used to access the cache 170 and various higher-level memory such as memory 13 (e.g., RAM memory.)

The bus interface unit 190 is only one of several interface units between the processor 100 and the system bus 11. The bus interface unit 190 functions to coordinate the flow of information related to instruction execution by the CPU 110.

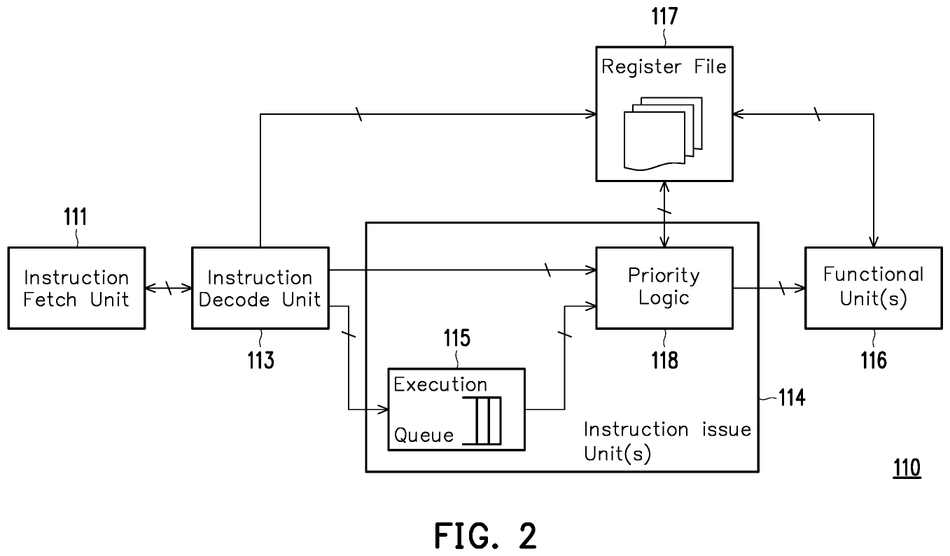

FIG. 2 is a block diagram illustrating instruction pipeline architecture of the CPU 110 as illustrated in FIG. 1 according to some embodiments of the disclosure. The CPU 110 includes an instruction fetch unit 111, an instruction decode unit 113, an instruction issue unit(s) 114, one or more functional unit(s) 116, and a register file 117. An output the instruction fetch unit 111 is coupled, via a multiple conductor bidirectional bus, to an input of an instruction decode unit 113 for decoding fetched instructions. An output of the instruction decode unit 113 is coupled, via a multiple conductor bidirectional bus, to the instruction issue unit(s) 114. The instruction issue unit(s) 114 is coupled, via a multiple conductor bidirectional bus, to the functional unit(s) 116. In the embodiments, the instruction issue unit(s) 114 includes an execution queue 115 and a priority scheduler 118, and the instruction from the instruction decode unit 113 has the option of dispatching to the execution queue 115 if there is data dependency or resource hazard, or bypassing the execution queue 115 and directly dispatching to the priority scheduler 118 where the instruction would be sent to the functional unit(s) 116 in the next cycle. The instruction decode unit 113, the instruction issue unit(s) 114, and the functional unit(s) 116 are respectively coupled to the register file 113 via a multiple conductor bidirectional bus. The functional unit(s) 116 may include a plurality of functional units, each of the plurality of functional units being configured to perform a predetermined operation. The instruction issue unit(s) 114 may include a plurality of instruction issue units, each of the plurality of instruction issue units being couple to a functional unit 116. In some embodiments, a scoreboard (not shown) is coupled between the instruction decode unit 113 and the register file 117 for tracking data dependency.

The instruction fetch unit 111 is configured to identify and implement the fetching of instructions including the fetching of groups of instructions. Instruction addresses are fetched by instruction fetch unit (either individually or in groups of two or more at a time) from cache 170 or memory 13, and each instruction fetched by may be placed in an instruction buffer. The instruction decode unit 113 is configured to perform instruction decoding to determine the type of the operation (OP code), source register(s), destination register(s). For example, a sample instruction may be “add C, A, B”, which means an add integer operation that adds the content of source register A (source operand data in register A) to the content of source register B (source operand data in register B), and then place the result data in the destination register C. Depending on the type of the operation designated by the instruction (Op-code), the instruction decode unit 113 issues the instruction to the appropriate functional unit 116 via the execution queue 115, or bypassing the execution queue 115 directly to priority scheduler 118.

As described above, the performance of the data processing system is reduced due to the long latency instructions such as load instructions, where subsequent depended instructions may be stalled in the execution queue 115 due to data dependency. Data dependency is referring to a situation where source register is the same as the destination register of previous instruction and the previous instruction is not yet completed. For example, a previously issued instruction has not written hack the result data to the register which is to be accessed by the instruction that is currently being decoded and to be issued. Such situation may be referred to read-after-write (RAW) dependency. In some cases, data dependency may be from write-after-write (WAW) or write-after-read (WAR) dependency where the previous instruction must write back or read from the register file before the subsequent instruction can write to the register file, respectively. The description focuses on the RAW dependency hut the issued instruction can be stalled in the execution queue 115 due to the other types of data dependency. In the embodiments, the instruction issue unit 114 further includes the execution queue 115 and the priority scheduler 118. The execution queue 115 may be a buffer and configured to have a plurality of entries for storing a plurality of instructions to be issued. The priority scheduler 118 may include a combination of logic circuits. The priority scheduler 118 is configured to determine whether the source operand data designated by the issue instruction is ready or not, and then send the issue instruction with highest priority to the functional unit 116. In the embodiments, an issued instruction having all of the source operand data ready (also referred to as “operand data ready”) has highest priority in the priority scheduler 118. Operand data ready refers to, for example, the operand data of the instruction is in the source register designated by the instruction, or the operand data may be forwarded from the functional unit designated by the instruction or other functional units.

If there is a data dependency, the instruction decode unit 113 puts the issue instruction in the execution queue 115, where the instruction waits until all of the source operand data is ready. If there is no data dependency, the instruction decode unit 113 issues the instruction to the priority scheduler 118, where the priority scheduler 118 sends the instruction to the functional unit 116. In the embodiments, the execution queue 115 can select and schedule one valid instruction in the queue with operand data ready for issuing to the functional unit 116. The priority scheduler 118 would select between the instruction from the execution queue 115 and an issued instruction from the instruction decode unit 113.

The functional unit 116 may include a number of functional units including, but not limited to, an arithmetic logic unit (ALU), shifter, an address generation unit (AGU), a floating-point unit (FPU), a load-store unit (LSU), and a branch execution unit (BEU). In some embodiments, a reservation station (not shown) may be coupled to the functional unit 116 to receive any ready instruction for out-of-order execution. The reservation station may receive information from the scoreboard or register that indicates the operand data is ready.

Although FIG. 2 illustrates that the priority scheduler 118 and execution queue 115 coupled between the functional unit 116 and the instruction decode unit 113, the disclosure is not limited thereto. In other embodiments, each priority logic 118 and each execution unit 115 are directly coupled to one single functional unit 116, among several sets of priority scheduler 118, execution unit 115, and functional unit 116. The instruction issue unit 114 would be directly coupled to the functional unit 116, where the priority scheduler 118 would be capable of scheduling the issue instructions based on the determination result of whether the source operand data is ready or not. In other words, each functional unit 116 has its own instruction issue unit 114.

In some embodiments, the execution queue 115 can be a first-in-first-out (FIFO) queue where only the first instruction can be issued to functional unit 116. In other embodiments, the execution queue 115 can be a reservation station. The reservation station is designed to issue any instruction in the execution queue 115 as long as the source operand data ready. The reservation station has higher performance than the FIFO queue but with a cost of complexity, area, and power. For example, if the execution queue has 8 entries and each entry has 3 source operands, then the reservation station is actively looking for 24 source operand data ready. In addition, the reservation station must keep source operand data, which is 24 sets of registers. In yet other embodiments, the FIFO execution queue 115 can be enhanced by allowing either of the first two entries to be issued from the execution queue. Coupling with the priority scheduler 118 to give highest priority to the issued instruction, the performance of the FIFO execution queue can match that of the reservation station.

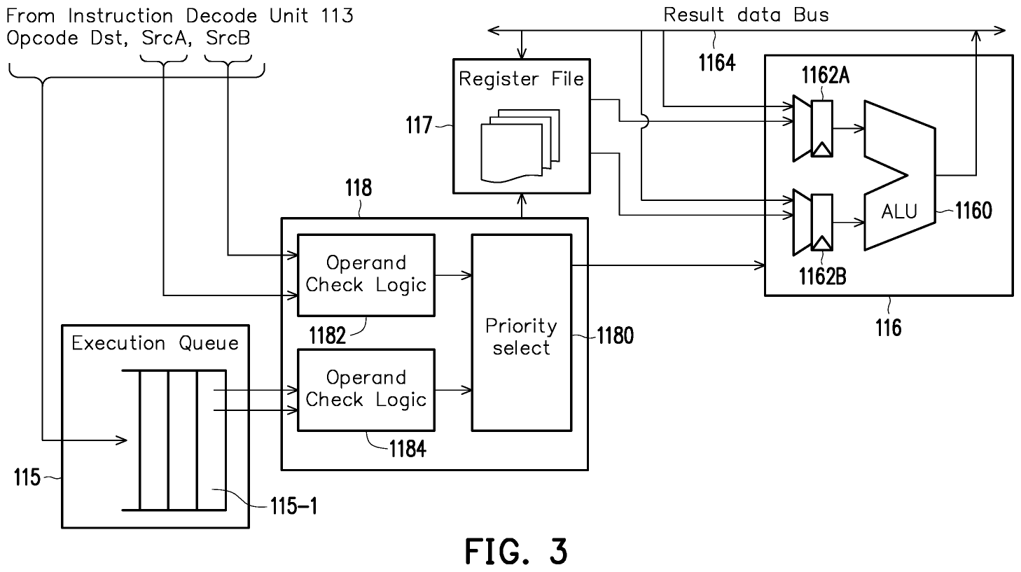

FIG. 3 is a diagram illustrating a priority scheduler 118 for selectively sends an instruction to a functional unit 116 according to some embodiments of the disclosure. The priority scheduler 118 is coupled to the instruction decode unit 113, the execution queue 115, the register file 117, and the functional unit 116. The priority scheduler 118 is coupled to the instruction decode unit 113 and the execution queue 115, where an instruction is selected between an instruction from the instruction decode unit 113 and an instruction from the execution queue 115 depending on the data dependency of the operand data corresponding to both instructions. The priority scheduler 118 is coupled to the register file 117 to read source operand data. The instruction decode unit 113 may couple to a register scoreboard (not shown) as to determine whether there is a data dependency on the operand data designated by the instructions from both the instruction decode unit 113 and the execution queue 115. The priority scheduler 118 is coupled to the functional unit 116 to select the data from register file 117 or one of the plurality of result data from result data bus 1164. In detail, the priority scheduler 118 includes a first operand check logic 1182 coupled to an instruction (e.g., a first instruction) received from instruction decode unit 113, a second operand check logic 1184 coupled to an instruction (e.g., a second instruction) received from the execution queue 115, and a priority-select logic 1180 coupled to the first and second operand check logic 1182, 1184. The first and second operand check logics 1182, 1184 read the operand register included in the register file 117 as to determine whether there are data dependency on the operand register designated by the first and second instruction. The priority-select logic 1180 selects the first instruction from the instruction decode unit 113 or the second instruction from the execution queue 115 based on the data dependency of the operand registers checked by the operand check logics 1182 and 1184. Note that the priority-select logic is different than the conventional selection logic which always gives priority to the oldest instruction. This priority select logic also consumes less power as the ready instruction from instruction decode unit 113 is dispatched directly to the functional unit 116 while in prior-art the ready instruction enters the execution queue 115, reads from the execution queue 115, and again reads data from the register file 117 to be dispatched to the functional unit 116.

With reference to FIG. 3, the priority scheduler 118 is coupled to the execution queue 115 to send the instruction from instruction decode unit 113 to the execution queue 115 if source data is not available as indicated by the operand check logic 1182. The priority scheduler 118 is also coupled to the execution queue 115 to read an entry from execution queue 115 if source operand data ready is determined by the operand check logic 1184 and selected by the priority-select logic 1180.

In FIG. 3, ALU instructions are used as an example. The functional unit 116 would include an ALU 1160 for executing the ALU instruction. The functional unit 116 would also include a multiplex logics 1162A, 1162B coupled the source operand data to each input of the ALU 1160. In the embodiments, an instruction is decoded by the instruction decode unit 113 in which the “Opcode, Dst, SrcA, SrcB” are shown in FIG. 3. The “Opcode” refers to an ALU instruction, “SrcA” and “SrcB” are the source operands referenced to entries in the register file 117, and “Dst” is the destination operand referenced to an entry in the register file 117. In one of the embodiments, the source operand, “SrcA”, “SrcB” and the destination operand “Dst” may refer to the same entry in the register file 117. The source operands, “SrcA” and “SrcB”, are sent to the operand check logic 1182 to check for data dependency. In some embodiments, a register scoreboard (not shown) may be used to check data dependency of the source operand registers. The source operand data may come from the register file 117 or result data bus 1164 or not available as indicated by the operand check logic 1182. The result data bus 1164 is a multiple-conductor communication bus in which the functional units place result data on the result data bus 1164 to write back to the register file 117. For performance, the operand check logic 1182 forwards the data from the result data bus 1164 to the functional unit 116 instead of waiting for data to be written to the register files 117. The multiplex logic 1162A selects between the register file 117 data and the forwarded result data bus 1164 in accordance with the operand check logic 1182, where the selection may be instructed through the priority select 1180 coupled between the operand check logic 1182 and the multiplex logic 1162A. The multiplex logic 1162A includes flip-flops to pipeline the actual execution function of ALU 1160 in the next clock cycle. Similarly, the source operand “SrcB” follows the similar path or operation from operand check logic 1182 to fetch source operand data from register file 117 or the result data bus 1164 to the multiplex logic 1162B to execution in the next pipeline stage by ALU 1160. If the instruction from the execution queue 115 is selected for dispatching to the functional unit 116 by the priority-select logic 1180, then the instruction from the execution queue 115 follows the similar process as described above with the instruction from instruction decode unit 113. Instead of the first operand check logic 1182, the selection of the source operand data would be instructed by the second operand check logic 1184 to the multiplex logics 1162A, 1162B.

The priority-select logic 1180 selects the instruction from instruction decode logic 113 or the execution queue 115 before accessing the register file 117. In other embodiments, due to timing paths, the instruction issue unit 118 may be in different clock cycle than the cycle of accessing the register file 117 and the result data bus 1164 for source operand data. The multiplexes 1162A and 1162B may select between more source operand data from the register file 117 and the result data bus 1164.

In the disclosure, the priority-select logic 1180 gives the instruction from the instruction decode unit 113 highest priority if the operand check logic 1182 indicates source operand ready. The “source-operand ready” instruction from the instruction decode unit 113 may be a new stream of instruction and should be executed immediately, so that subsequent instructions are not blocked. In the disclosure, the execution queue 115 may be FIFO queue which is much simpler in implementation, smaller area, and less power dissipation in comparison to fully out-of-order queue such as the reservation station where any entry in the execution queue 115 can be selected for issuing with the oldest priority-select logic.

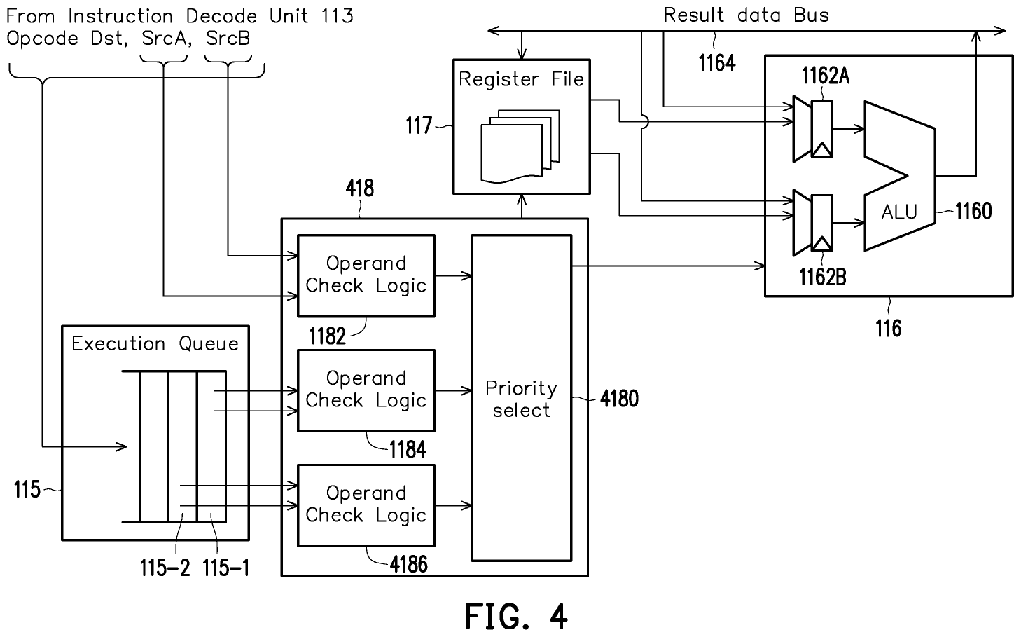

FIG. 4 is a diagram illustrating a priority scheduler for selectively sends an instruction to a functional unit according to some embodiments of the disclosure. In the embodiments illustrated in FIG. 4, first 2 entries of the execution queue 115 may be selected for dispatching to the functional unit instead of pushing through the first entry of the execution queue 115 only. In the embodiments, the priority-select logic 1180 selects instruction from the instruction decode logic 113, first entry of the execution unit 115, and second entry of the execution unit 115, with the same priority order. The priority scheme as described in this disclosure is simpler, smaller area, less power dissipation, and yet may provide same or better performance to the fully out-of-order execution queue.

With reference to FIG. 4, an instruction is received from the instruction decode unit 113, where the instruction is coupled to a priority scheduler 418 and the execution queue 115. The priority scheduler 418 selects the instruction from the instruction decode unit 113 or instructions from the execution queue 115, and then provides the selection information corresponding to the selected instruction to the functional unit 116 for execution. In additional to the embodiment illustrated in FIG. 3, the priority scheduler 118 of the embodiments further includes a third operand check logic 4186 for checking operand data designated by a second entry 115-2 of the execution queue 115. Instead of checking the first entry 115-1 of the execution queue 115 for operand data ready through the second operand check logic 1184 only, the embodiments also check for operand data ready of the instruction being placed in the second entry of the execution queue 115 through the third operand check logic 4186. If the instruction placed in the second entry 115-2 has an operand data ready before the instruction placed in the first entry 115-1, the priority select logic 4180 would select the instruction of the second entry 115-2 for execution in the functional unit 116. The operation and function of the functional unit 116 is the same as the embodiments of FIG. 3, and therefore, detail description of which may be referred to the description of FIG. 3.

The operand check logics 1182, 1184, 4186 may be any of the method to handle data dependency such as register scoreboard, register renaming, re-order buffer, etc. The data dependency checking logic includes fetching source operand data from the register file 117, the result data bus 1164, or temporary storage of data such as future file (not shown), re-order buffer (not shown), and large physical register file (not shown) which is a combination of architectural and renamed registers.

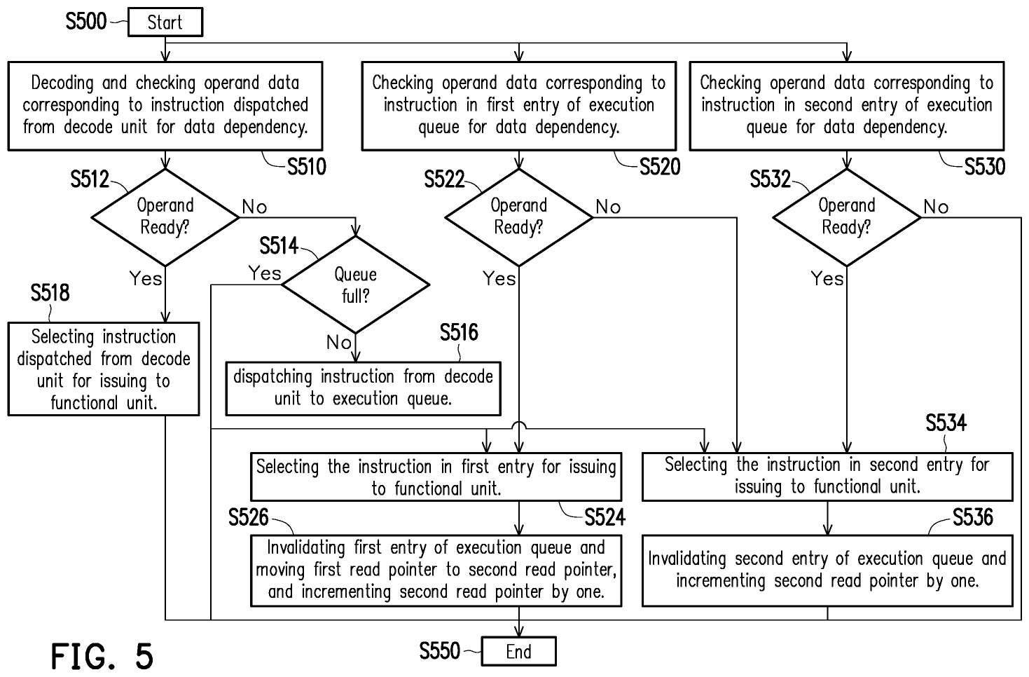

FIG. 5 is a flowchart diagram illustrating an issuance of an instruction from either the instruction decode unit 113 or the execution unit 115 to the functional unit 116 through the priority scheduler 118 according to some embodiments of the disclosure. In the followings, the process would be explained with the structure of the embodiments illustrated in FIGS. 3 and 4. In step S500, the start of a clock cycle where the priority scheduler 118 begins to evaluate the instruction for issue. In the embodiments, a highest priority is given to the instruction from instruction decode unit 113 where in step S510, the source operands are decoded and check for data dependency in the operand check logic 1182. In step S512, if the source operand ready, then the instruction is selected for issue in step S518 by the priority select logic 1180. No other action is taken in this clock cycle as the process is ended in step S550. Back to the step S512, if the source operands are not ready, the instruction from instruction decode unit 113 checks for the execution queue full in step S514. If the execution queue 115 is full, the instruction is stalled in the instruction decode unit 113 (not shown), and the process for scheduling the instruction from the instruction decode unit 113 would start again in next cycle. If the execution queue 115 is not full, the decoded instruction from the instruction decode unit 113 is sent to the execution queue 115 in step S516. In parallel to the decode instruction in step S510, the first instructions in first entry 115-1 of the execution unit 115 is accessed by the operand check logic 1184 to check for data dependency. If the operand data of the first instruction is ready in step S522, the instruction stored in the first entry of the execution queue 115 may be issued to the functional unit 116 based on priority. Afterward, the process goes to step S524 for a priority selection between the instructions from the instruction decode unit 113 and the first entry of the execution queue 115. In step S524, the process determines whether the instruction from the execution queue 115 has the priority to issue to the functional unit 116 over the instruction from the instruction decode unit 113. In detail, if step S512 results in No and step S522 results in Yes, the first instruction has the priority and is selected for issuing to the functional unit 116 by the priority select logic 1180 in step S524. In step S526, the first instruction in the execution queue 115 is shifted out of the execution queue 115. Furthermore, a first read pointer is set to the second read pointer, and a second read pointer is incremented by 1 for the execution queue 115, which may be implemented by a rotating pointer buffer.

As described in the embodiments of FIG. 4, the second entry 115-2 of the execution queue 115 may also be considered for selection based on priority. That is, if both the instructions from the instruction decode unit 113 and the first entry 115-1 of the execution queue 115 has data dependency, the instruction from the second sentry 115-2 of the execution queue 115 may be next in line for issuing to the functional unit 116. With reference to FIG. 5, if step S512 and step S522 resulted in No and step S532 resulted in Yes, the second instruction would be selected for issued to the functional unit 116 by the priority select logic 1180 in step S534. In step S536, the second instruction in the execution queue 115 is shifted out of the execution queue 115. Furthermore, the second read pointer is incremented by 1 for the execution queue 115, which may be implemented with rotating pointer buffer. If all of the steps S512, S522, and S532 resulted in No, then no instruction is dispatched to the functional unit 116 in this clock cycle. The process would start over again from step S500 in the next clock cycle.

In accordance with one of the embodiments of the disclosure, a microprocessor is provided. The microprocessor includes a register file having a plurality of registers, an instruction decode unit, a function unit, an execution queue having a plurality of entries and coupled between the functional unit and the instruction, and a priority scheduler coupled between the functional unit, the instruction decode unit, and the execution queue. The instruction decode unit decodes an instruction for at least one source operand and issues the instruction to the priority scheduler or the execution queue. The functional unit receives the issue instruction and performs an operation designated by the issue instruction. In the execution queue, each entry of the execution queue stores a queued instruction originated from the instruction decode unit in which at least one source operand of the queued instruction has a data dependency at a clock cycle when the queued was to be issued. In addition, the priority scheduler prioritizes one of the issued instruction and the queued instruction based on the availability of operand data corresponding to the issued instruction and the queued instruction_, and then issues one of the issued instruction and queued instruction to the functional unit as the issue instruction based on the respective priority assigned to the issued instruction and the queued instruction;

In accordance with one of the embodiments of the disclosure, a method for issuing an issue instruction to a functional unit for execution with priority scheduling is provided. The method comprises the following steps. An issued instruction is received from an instruction decode unit, and a queued instruction is received from an execution queue. One of the issued instruction and the queued instruction is prioritized based on availability of operand data corresponding to the issued instruction and the queued instruction. Then, one of the issued instruction or the queued instruction is issued to the functional unit as the issue instruction based on the respective priority assigned to the issued instruction and the queued instruction.

In accordance with one of the embodiments of the disclosure, a data processing system is provided. The data processing system includes a microprocessor, a main memory coupled to the microprocessor, a bus bridge coupled to the microprocessor, and an input/output device coupled to the bus bridge. The microprocessor includes a register file having a plurality of registers, an instruction decode unit, a function unit, an execution queue having a plurality of entries and coupled between the functional unit and the instruction, and a priority scheduler coupled between the functional unit, the instruction decode unit, and the execution queue. The instruction decode unit decodes an instruction for at least one source operand and dispatches the instruction to the priority scheduler or the execution queue. The functional unit receives the issue instruction and performs an operation designated by the issue instruction. In the execution queue, each entry of the execution queue stores a queued instruction originated from the instruction decode unit in which at least one source operand of the queued instruction has a data dependency at a clock cycle when the queued was to be issued. In addition, the priority scheduler includes a first operand check logic coupled to the instruction decode unit, a second operand check logic coupled to the execution queue, and a priority select logic coupled to the first and second operand check logics respectively. The priority select logic is configured to prioritize the instruction directly received from the instruction decode unit through the first operand check logic or a queued instruction received from the execution queue through the second operand check logic, where the instruction sent directly from the instruction decode unit with the corresponding operand data available has higher priority over the queued instruction. The priority select logic issues one of the instruction directly from the instruction decode unit or the queued instruction to the functional unit as the issue instruction based on the respective priority of the instruction directly from the instruction decode unit without data dependency over and the queued instruction.

The foregoing has outlined features of several embodiments so that those skilled in the art may better understand the detailed description that follows. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

1. A microprocessor, comprising:
an instruction decode unit, decoding an instruction for at least one source operand, dispatching the instruction;
a functional unit, performing an operation designated by an issue instruction;
an execution queue, coupled between the functional unit and the instruction, having a plurality of entries, each entry storing the dispatched instruction having a data dependency as a queued instruction; and
a priority scheduler, coupled between the functional unit, the instruction decode unit, and the execution queue, prioritizing one of the dispatched instruction and the queued instruction based on the availability of operand data corresponding to the dispatched instruction and the queued instruction, and issuing one of the dispatched instruction and queued instruction to the functional unit as the issue instruction based on the respective priority assigned to the dispatched instruction and the queued instruction, wherein the dispatched instruction received directly from the instruction decode unit with the corresponding operand data available has higher priority over the queued instruction received from the execution queue, and the dispatched instruction and queued instruction designate the same functional unit.

2. The microprocessor of claim 1, wherein the issue instruction is sent to the functional unit with the operand data of the issue instruction from a register file or result data corresponding to the operand data of the issue instruction forwarded from a functional unit.

3. The microprocessor of claim 1, wherein the priority scheduler comprises:
a first operand check logic coupled to the instruction decode unit for receiving the issued instruction, and determining availability of the operand data corresponding to the issued instruction;
a second operand check logic, coupled to the execution queue for receiving the queued instruction in a first entry of the execution queue, and determining availability of the operand data corresponding to the queued instruction; and
a priority select logic, coupled to the first and second operand check logics respectively, selecting one of the issued instruction and queued instruction that has operand data ready to issue to the functional unit.

4. The microprocessor of claim 3, wherein the priority scheduler further comprises:
a third operand check logic, coupled to the execution queue for receiving another queued instruction in a second entry of the execution queue, and determining availability of operand data corresponding to the queued instruction of the second entry,
wherein the queued instruction of the first entry with the corresponding operand data available has higher priority over the queued instruction of the second entry with the corresponding operand data available,
wherein the queued instruction of the second entry having the corresponding operand data available has higher priority over the queued instruction of the first entry with the corresponding operand data not available.

5. The microprocessor of claim 4, wherein the execution queue includes a rotating pointer comprising:
a first read pointer corresponding to the queue instruction of the first entry in the execution queue, wherein a second read pointer corresponding to the queue instruction of the second entry is copied to the first read pointer, and the second read pointer is incremented by 1 if the queued instruction of the first entry is selected by the priority scheduler for issuing to the functional unit; and
a second read pointer corresponding to the queued instruction of second entry in the execution queue, wherein the second read pointer is incremented by 1 if the queued instruction of the second entry is selected by the priority scheduler for issuing to the functional unit.

6. The microprocessor of claim 1, wherein the issued instruction from the instruction decode unit is stalled if the corresponding operand data is not ready and the execution queue is full.

7. The microprocessor of claim 1, wherein the priority scheduler selected one of the issued instruction and the queued instruction as the issue instruction before accessing the register file or result data bus for operand data.

8. The microprocessor of claim 1, wherein
the issued instruction from instruction decode unit and the queued instruction from the execution queue independently access the register file and the result data bus for the corresponding operand data, and
the priority scheduler selects the operand data based on the priority of the issued instruction and the queued instruction for issuing to the functional unit.

9. A method of issuing an issue instruction to a functional unit for execution with priority scheduling, comprising:
receiving a dispatched instruction from an instruction decode unit and a queued instruction from an execution queue, wherein the dispatched instruction and the queued instruction designate a same functional unit;
prioritizing one of the dispatched instruction and the queued instruction based on availability of operand data corresponding to the issued instruction and the queued instruction, wherein the dispatched instruction with the corresponding operand data available and received directly from the instruction decode unit by the prioritize scheduler is prioritized over the queued instruction received from the execution queue with the corresponding operand data available; and
issuing one of the dispatched instruction and the queued instruction to the functional unit as the issue instruction based on the respective priority assigned to the dispatched instruction and the queued instruction.

10. The method of claim 9, wherein the issue instruction is sent to the functional unit with the operand data of the issue instruction from a register file or result data corresponding to the operand data of the issue instruction forwarded from a functional unit,
wherein the dispatched instruction is placed to an execution queue as one of queue entries in the execution queue when a corresponding operand data of the dispatched instruction has data dependency.

11. The method of claim 9, further comprising:
determining availability of the operand data corresponding to the issued instruction;
determining availability of the operand data corresponding to the queued instruction; and
selecting one of the issued instruction and queued instruction that has operand data ready to issue to the functional unit.

12. The method of claim 11, wherein the queued instruction comprises a first queued instruction stored in a first entry of the execution queue and a second queued instruction stored in a second entry of the execution queue, wherein the step of determining the availability of the operand data corresponding to the queued instruction comprise:
determining availability of the operand data corresponding to the first queued instruction;
determining availability of the operand data corresponding to the second queued instruction;
prioritizing the first queued instruction with the corresponding operand data available over the second queued instruction with the corresponding operand data available; and
prioritizing the second queued instruction having the corresponding operand data available over the first queued instruction with the corresponding operand data not available.

13. The method of claim 12, further comprising:
copying the second read pointer corresponding to the queue instruction of the second entry in the execution queue to a first read pointer wherein the first read pointer corresponding to the queue instruction of the first entry, and incrementing the second read pointer by 1 if the first queued instruction is selected by the priority scheduler for issuing to the functional unit; and
incrementing a second read pointer corresponding to the queued instruction of second entry in the execution queue by 1 if the queued instruction of the second entry is selected by the priority scheduler for issuing to the functional unit.

14. The method of claim 9, further comprising:
stalling the issued instruction from the instruction decode unit the corresponding operand data is not ready and the execution queue is full.

15. The method of claim 9, further comprising:
selecting one of the issued instruction and the queued instruction as the issue instruction before accessing the register file or result data bus for operand data.

16. The method of claim 9, wherein
the issued instruction from instruction decode unit and the queued instruction from the execution queue independently access the register file and the result data bus for the corresponding operand data, and
the operand data is selected based on the priority of the issued instruction and the queued instruction for issuing to the functional unit.

17. A data processing system, comprising:
a microprocessor, wherein the microprocessor includes:
a register file, having a plurality of registers;
an instruction decode unit, decoding an instruction for at least one source operand, issuing the instruction;
a functional unit, performing an operation designated by an issue instruction;
an execution queue, coupled between the functional unit and the instruction, having a plurality of entries, each entry storing a queued instruction originated from the instruction decode unit in which at least one source operand of the queued instruction has a data dependency at a clock cycle when the queued was to be issued; and
a priority scheduler, including a first operand check logic coupled to the instruction decode unit, a second operand check logic coupled to the execution queue, and a priority select logic coupled to the first and second operand check logics respectively, wherein the priority select logic is configured to prioritize the instruction directly received from the instruction decode unit through the first operand check logic or a queued instruction received from the execution queue through the second operand check logic, wherein the instruction received directly from the instruction decode unit with the corresponding operand data available has higher priority over the queued instruction received from the execution queue, and issuing, to the functional unit, one of the instruction directly received from the instruction decode unit or the queued instruction received from the execution queue as the issued instruction based on the respective priority of the instruction and the queued instruction, wherein the issued instruction and queued instruction designate the same function unit;
a main memory coupled to the microprocessor;
a bus bridge coupled to the microprocessor; and
an input/output device coupled to the bus bridge.

18. The data processing system of claim 17, wherein the issue instruction is sent to the functional unit with the operand data of the issue instruction from a register file or result data corresponding to the operand data of the issue instruction forwarded from a functional unit.

19. The data processing system of claim 17, wherein the priority scheduler further comprises:
a third operand check logic, coupled to the execution queue for receiving another queued instruction in a second entry of the execution queue, and determining availability of operand data corresponding to the queued instruction of the second entry,
wherein the queued instruction of the first entry with the corresponding operand data available has higher priority over the queued instruction of the second entry with the corresponding operand data available,
wherein the queued instruction of the second entry having the corresponding operand data available has higher priority over the queued instruction of the first entry with the corresponding operand data not available.

20. The data processing system of claim 19, wherein the execution queue includes a rotating pointer comprising:
a first read pointer corresponding to the queue instruction of the first entry in the execution queue, wherein a second read pointer corresponding to the queue instruction of the second entry is copied to the first read pointer, and the second read pointer is incremented by 1 if the queued instruction of the first entry is selected by the priority scheduler for issuing to the functional unit; and
a second read pointer corresponding to the queued instruction of second entry in the execution queue, wherein the second read pointer is incremented by 1 if the queued instruction of the second entry is selected by the priority scheduler for issuing to the functional unit.
